(19) United States
(12) Patent Application Publication
(10) Pub. No.: US 2010/0213880 A1
(43) Pub. Date: Aug. 26, 2010

(54) LED LIGHT WITH SPECIAL EFFECTS

(76) Inventor: Tseng-Lu CHIEN, Walnut, CA (US)

Correspondence Address: BACON & THOMAS, PLLC, 625 SLATERS LANE, FOURTH FLOOR, ALEXANDRIA, VA, 22314-1176, US

(21) Appl. No.: 12/710,561

(22) Filed: Feb. 23, 2010

Related U.S. Application Data
(63) Continuation of application No. 12/622,100, filed on Nov. 19, 2009.
Application No. 12/622,100 is a continuation of application No. 12/232,035, filed on Sep. 10, 2008.
Application No. 12/232,035 is a continuation of application No. 11/566,322, filed on Dec. 4, 2006, now abandoned.
Application No. 11/566,322 is a continuation of application No. 12/073,095, filed on Feb. 29, 2008, now Pat. No. 7,726,869.
Application No. 12/073,095 is a continuation of application No. 12/566,322, filed on Sep. 24, 2009.
Application No. 12/566,322 is a continuation of application No. 12/502,661, filed on Jul. 14, 2009.
Application No. 12/502,661 is a continuation of application No. 11/092,742, filed on Mar. 30, 2005.
Application No. 11/092,742 is a continuation of application No. 11/094,156, filed on Mar. 31, 2005, now Pat. No. 7,318,653.
Application No. 11/094,156 is a continuation of application No. 11/094,155, filed on Mar. 31, 2005.
Application No. 11/094,155 is a continuation of application No. 10/954,189, filed on Oct. 1, 2004, now abandoned.
Application No. 10/954,189 is a continuation of application No. 10/902,123, filed on Jul. 30, 2004.
Application No. 10/902,123 is a continuation of application No. 10/883,719, filed on Jul. 6, 2004, now abandoned.
Application No. 10/883,719 is a continuation of application No. 10/341,519, filed on Jan. 14, 2003, now Pat. No. 6,945,663.
Application No. 10/341,519 is a continuation of application No. 12/545,992, filed on Aug. 24, 2009.
Application No. 12/545,992 is a continuation of application No. 12/624,621, filed on Nov. 24, 2009.
Application No. 12/624,621 is a continuation of application No. 12/622,000, filed on Nov. 19, 2009.
Application No. 12/622,000 is a continuation of application No. 12/318,471, filed on Dec. 30, 2008.
Application No. 12/318,471 is a continuation of application No. 12/318,470, filed on Dec. 30, 2008.
Application No. 12/318,470 is a continuation of application No. 12/318,473, filed on Dec. 30, 2008.
Application No. 12/318,473 is a continuation of application No. 12/292,153, filed on Nov. 12, 2008.
Application No. 12/292,153 is a continuation of application No. 12/232,505, filed on Sep. 18, 2008.
Application No. 12/232,505 is a continuation of application No. 12/149,963, filed on May 12, 2008, now Pat. No. 7,722,230.
Application No. 12/149,963 is a continuation of application No. 12/149,964, filed on May 12, 2008.
Application No. 12/149,964 is a continuation of application No. 12/073,095, filed on Feb. 29, 2008, now Pat. No. 7,726,869.
Application No. 12/073,095 is a continuation of application No. 12/073,889, filed on Mar. 11, 2008.
Application No. 12/073,889 is a continuation of application No. 12/007,076, filed on Jan. 7, 2008, now Pat. No. 7,726,841.
Application No. 12/007,076 is a continuation of application No. 12/003,691, filed on Dec. 31, 2007, now Pat. No. 7,726,839.
Application No. 12/003,691 is a continuation of application No. 12/003,809, filed on Jan. 2, 2008.
Application No. 12/003,809 is a continuation of application No. 11/806,711, filed on Jun. 4, 2007, now Pat. No. 7,618,150.
Application No. 11/806,711 is a continuation of application No. 11/806,285, filed on May 31, 2007.
Application No. 11/806,285 is a continuation of application No. 11/806,284, filed on May 31, 2007, now Pat. No. 7,632,004.
Application No. 11/806,284 is a continuation of application No. 11/527,628, filed on Sep. 27, 2006, now Pat. No. 7,611,253.
Application No. 11/527,628 is a continuation of application No. 11/527,629, filed on Sep. 27, 2006.
Application No. 11/527,629 is a continuation of application No. 11/498,874, filed on Aug. 4, 2006.
Application No. 11/498,874 is a continuation of application No. 11/527,631, filed on Sep. 27, 2006, now abandoned.
Application No. 11/527,631 is a continuation of application No. 12/545,992, filed on Aug. 24, 2009.
Application No. 12/545,992 is a continuation of application No. 12/292,580, filed on Nov. 21, 2008.
Application No. 12/292,580 is a continuation of application No. 11/498,881, filed on Aug. 4, 2006, now Pat. No. 7,568,829.
Application No. 11/498,881 is a continuation of application No. 11/255,981, filed on Oct. 24, 2005, now Pat. No. 7,455,444.
Application No. 11/255,981 is a continuation of application No. 11/184,771, filed on Jul. 20, 2005, now Pat. No. 7,677,745.
Application No. 11/184,771 is a continuation of application No. 11/152,063, filed on Jun. 15, 2005, now Pat. No. 7,651,365.
Application No. 11/152,063 is a continuation-in-part of application No. 11/094,215, filed on Mar. 31, 2005.
Application No. 11/094,215 is a continuation-in-part of application No. 11/092,741, filed on Mar. 30, 2005, now Pat. No. 7,232,251.
Application No. 11/092,741 is a continuation-in-part of application No. 11/883,747, filed on Aug. 6, 2007.
Application No. 11/883,747 is a continuation of application No. 11/498,874, filed on Aug. 4, 2006.
Application No. 11/498,874 is a continuation of application No. 11/527,629, filed on Sep. 27, 2006.
Application No. 11/527,629 is a continuation of application No. 11/527,628, filed on Sep. 27, 2006, now Pat. No. 7,611,253.
Application No. 11/527,628 is a continuation of application No. 11/806,284, filed on May 31, 2007, now Pat. No. 7,632,004.
Application No. 11/806,284 is a continuation of application No. 11/806,258, filed on May 30, 2007, now Pat. No. 7,723,867.
Application No. 11/806,258 is a continuation of application No. 11/806,711, filed on Jun. 4, 2007, now Pat. No. 7,618,150.

(51) Int. Cl. H05B 37/02

(52) U.S. Cl. 315/317

(57) ABSTRACT

The current invention teach LED light device has special effects which meet persistence of vision theory to have LED or LEDs or LED array has quickly changing than the human eye response time within 1/16 to 1/24 second to let people see the message display from the said light device with special message, time, drawing, light patterns, light color changing. It also teach a sealed-unit with receiving means to receive all eye-catching shades to make said light device been used for desktop or outlet for desire power source or interchangeable power source. Also teach the power saving and cost saving LED light device.

This is continuation of U.S. patent application Ser. Nos. 12-624,621, 12-622,100, 12-318,471, 12-318,470, 12-318,473, 12-292,153, 12-232,505, 12-232,035, 12-149,963, 12-149,964, 12-073,095, 12-073,889, 12-007,076, 12-003,691, 12-003,809, 11-806,711, 11-806,285, 11-806,284, 11-566,322, 11-527,628, 11,527,629, 11-498,874, 12-545,992, 12-806,711, 12-806,285, 12-806,284, 12-566,322, 12-527,628, 12-527,629, 12-527,631, 12-502,661, 11-498,881, 11-255,981, 11-184,771, 11-152,063, 11-094,215, 11-092,742, 11-092,741, 11-094,156, 11-094,155, 10-954,189, 10-902,123, 10-883,719, 10-883,747, 10-341,519, 12-545,992, 12-292,580

This is confinuously of U.S. patent application Ser. No. ______ Field on Feb. 25, 2010 for LED power failure Light

This is continuously of U.S. patent application Ser. No. ______ Field on Feb. 25, 2010 for LED light device has special effects

This is continuously tiling of U.S. patent application Ser. No. ______ Field on Feb. 25, 2010 for LED light device has more than 1 reflect leans for plurality of image

This is continuation of U.S. patent application Ser. No. 12-624,621 Field on Nov. 24, 2009 file for the “project device or assembly for variety of LED light”

This is continuation of U.S. patent application Ser. No. 12-622,000 Field on Nov. 24, 2009 file for the “Interchangeable Universal Kits for all LED light”

This is continuation of U.S. patent application Ser. No. 12-318,471 Field Dec. 30, 2008 file for the “LED night light with pinhole imaging”

This is continuation of U.S. patent application Ser. No. 12-318,470 Field Dec. 24, 2008 file for the “LED night light with Projection features”

This is continuation of U.S. patent application Ser. No. 12-318,473 Field Dec. 8, 2008 file for the “LED night light with laser or hologram element”

This is continuation of U.S. patent application Ser. No. 12-292,153 Field Nov. 8, 2008 file for the “LED night light with Projection or imaing features”

This is continuation of U.S. patent application Ser. No. 12-232,505 Field Sep. 16, 2008 file for the “LED night light with Projection features”

This is continuation of U.S. patent application Ser. No. 12-149,963 Filed on Apr. 21, 2008 file for the “Removable LED light device.

This is continuation of U.S. patent application Ser. No. 12-149,964 Filed on Apr. 21, 2008 file for the “Surface Mounted Device with LED light”.

This is continuation of U.S. patent application Ser. No. 12-073,095 Filed on Feb. 29, 2008 file for the “LED Track light device.

This is Continuation of U.S. patent application Ser. No. 12/073,889, filed on Feb. 12, 2008 file for the “LED light with changeable position with Prefereable power source”.

This is Continuation of U.S. patent application Ser. No. 12/007,076, filed on Jan. 7^{th} 2008 file for the “LED light with changeable geometric system”

This is Continuation of U.S. patent application which the Ser. No. 12/003,691, filed on Dec. 31^{th} 2007 file for the “LED light with changeable geometric dimension features”

This is Continuation of U.S. patent application which the Ser. No. 12/003,809, filed on Jan. 2, 2008 file for the “LED light with changeable features”

This is Continuation of U.S. patent application which the Ser. No. 11/806,711 filed on Apr. 30, 2007 file for the “Multiple LED light with adjustable angle features”

This application is continuation of U.S. patent application Ser. No. 11/806,285. LED Night light with outlet device filed on Apr. 30, 2007

This application is continuation of U.S. patent application Ser. No. 11/806,284 LED Night light with more than 1 optics means filed on Apr. 28, 2007

This application is continuation of U.S. patent application Ser. No. 11/527,628. Multiple function Night light with air fresher filed on Sep. 27, 2006.

This application is continuation of U.S. patent application Ser. No. 11/527,629. LED Night light with interchangeable display unit filed on Sep. 27, 2006.

This application is continuation of U.S. patent application Ser. No. 11/498,874. Area illumination Night light filed on Aug. 4, 2006.

This application is continuation of U.S. patent application Ser. No. 11/527,631. LED Time piece night light field on Sep. 27, 2006.

This application is continuation of U.S. patent application Ser. No. 12-545,992 LED time piece Night light filed division of 11-527,631 on Aug. 24, 2009.

This application is continuation of U.S. patent application Ser. No. 12-292,580 LED Time Piece Night light filed division of 11-527,631 on Aug. 24, 2009.

This application is continuation of U.S. patent application of Ser. No. 11/498,881, Poly Night light filed on Aug. 4, 2006.

This application is continuation of U.S. patent application of Ser. No. 11/255,981, Multiple light source Night Light filed on Oct. 24^{th}, 2005.

This application is continuation of U.S. patent application of Ser. No. 11/184,771 Light Device with EL elements field on Oct. 11^{th}, 2005

This application is continuation of U.S. patent application of Ser. No. 11/1152,063 Outlet adaptor with EL field on Jun. 5, 2005

This application is continuation of U.S. patent application of Ser. No. 11/094,215 LED night light with liquid medium filed on Mar. 31, 2005

This application is continuation of U.S. patent application Ser. No. 11/094,215, filed Mar. 30^{th}, 2005 LED Night light with Liquid optics medium.

This application is continuation of U.S. patent application Ser. No. 11/092,741, filed Mar. 30^{th}, 2005 Night light with fiber opotics.

This application is continuation of U.S. patent application Ser. No. 10/883,747, filed Jul. 6^{th}, 2004 Fiber Optic light kits for footwear.

This application is continuation of U.S. patent application Ser. No. 11/498,874, Area Illumination for LED night light

This application is continuation of U.S. patent application Ser. No. 11/527,629. Time Piece with LED night light,

This application is continuation of U.S. patent application Ser. No. 11/527,628. Multiple Function Night light with Air Freshener

This application is continuation of U.S. patent application Ser. No. 11/806,284 LED Night light with more than one optics mediums

This application is continuation of U.S. patent application Ser. No. 11/806,285 LED Night Light with multiple function

This application is continuation of U.S. patent application Ser. No. 11/806,711 Multiple LEDs Light with adjustable angle function

Above listed parent filing case related apply physic optic theory to the said Night light for outlet or battery or solar or other power source which same as current invention to apply the physics optics theory to create plurality of LED light image on the surface to present to viewers which has more than 1 light source, more than 1 function, more than 1 optics means, more than 1

### BACKGROUND

The current invention to teach apply the physics persistence of vision to the said Desktop or outlet plug-in LED light device to make the LED or LEDs or LED array's light effects to be seen by viewers for light patterns, message display, time display, color changing, words display, logo display, advertisement display. It also teach the saled-unit with self-test certification issued by laboratories has add-on shades to make exciting and eye-catching LED device. Both has the desire power source, circuit, switch, sensor, timer and relative parts and accessories to make the light has long life and convenient to people to use.

The current invention has 12 features as below:
1. LED light device has special effects consist of;
   At least one of LED array are arranged on the substrate.
   At least one of spin means to offer the certain rotating times per minute (hereafter as RPM) to make the substrate means rotate under predetermined RPM along the axis extended from the spin means.
   The said LED or LEDs will turn on and turn off under predetermined pattern, time, color, function, effects and connect with related circuit, switch, sensor, timer, auto turn on and turn off, power source (DC or AC or Interchangeable Power source), gear sets, motor, Integrated circuit (hereafter as IC), conductive means to make desired desire light effects, performance including the light patterns, message display, time display, color changing, words display, logo display, advertisement display.
   The improvement of the said LED or LEDs light performance meet requirement of persistence of vision theory to create the illusion based on inertia of a human eye which has 1/16 to 1/24 second to response the image and the said LED or LEDs light performance is quickly than the 1/16 to 1/24 second to make the desire image to be seen by viewer.
   The said LED light device has persistence of vision properties has housing to arrange the said substrate means, spin means, LED or LED or LED arrays, motor means, switch, sensor, circuit, IC, power source means within the said housing for desk top or outlet plug-in application.
   The said LED light device further incorporate the vibration absorb means to absorb all motor or spin means vibration while people put the said device on desk top or plug-in outlet.
2. The LED light device has special effects consist of;
   At least one LED or LEDs fit into the sealed unit which has its own safety certification issued by laboratories to meet the relative safety standard and has the receiving means to allow different shades to add on the said sealed unit to become a final LED light device.
   The said add on shades which is made by plastic, paper, wood, laser piece, hologram piece, air-bag, bloom, assembly pieces, light block out means, grilled piece to make the said final LED light device has special light effects and eye-catching appearance.
   The said final LED light device no need to pass any other laboratories further testament because the sealed unit already got its own safety testament certification so the said shade can use any kind of material to made of
   The said Final LED light device incorporate with power source which may selected from battery, outlet, or interchangeable power source between Direct current and Alternative power source for desk top or plug-in application.
3. The LED light device has special effects, the said the illusion is based on inertia of a human eye which is within the 1/16 to 1/24 second range to response the image to been seen by people's eye and LED or LEDs light changing have to be faster than the 1/16 to 1/24 second to let the people eye to remember the last image of LED or LEDs to become a Continuously picture to viewer.
4. The LED light device has special effects, the said Housing can be a market available tap light which touch the top cover can activate the said device.
5. The LED light device has special effects, the said housing can be a ball shape and has rotating means inside the ball means to show the special effects and spin means under the ball means to has better appearance.
6. The LED light device has special effects, the said spin means is a motor with fan blades substrate to install the LED or LEDs or LED array within the said fan blade.
7. The LED light device has special effects, the said spin means is a motor with bars substrate to install the LED or LEDs or LED array within the said bar.
8. The LED light device has special effects, the said spin means is a motor with frame substrate to install the LED or LEDs or LED array within the said frame.
9. The LED light device has special effects, the said spin means is a motor with round disc substrate to install the LED or LEDs or LED array within the said disc.
10. The LED light device has special effects, the said spin means is a moto with geometric shape substrate to install the LED or LEDs or LED array with the said geometric shape substrate.
11. The LED light device has special effects, the said switch, sensor, timer means to control the circuit to make its function as predetermined design.
12. The LED light device has special effects, the said power source and be in DC power source, AC power source, or interchangeable power source which may come form battery, USB, Generator, chemical power source, green power source, wind power source, outlet, extension cord, power strips or other forms from the power generator device(s).
13. The LED light device has power saving features consist of;
   At least one of LED or LEDs for light source.
   At least one housing has space to install related preferred means which in desire combination select from circuit means, conductive means, electric components parts and accessories, switch means, sensor means, integrated circuit (IC), micro controller to connect with conventional market available power source to make the said LED or LEDs turn on and turn off under predetermined function, effects, On/Off on certain % duration, cycles, color, brightness.
   The said power saving features made by control means to make the LED or LEDs turn-on and turn-off duration time on certain percentage of the each cycle. The said cycle means each second has certain times for turn-on and turn-off. The cycles number meet the persistence of vision of human eye which more quickly than the human eyes response time within 1/24 to 1/16 second so can make people see the blinking LED or LEDs look as continuously on status.
14. The LED light device has cost saving features consist of;
   At least one of LED or LEDs for light source.
   At least one housing has space to install related preferred means which in desire combination select from circuit means, conductive means, electric components parts and accessories, switch means, sensor means, integrated circuit (IC), micro controller to connect with conventional market available power source to make the said LED or LEDs turn on and turn off under predetermined function, effects, On/Off on certain % duration, cycles, color, brightness.
   The said Power source preferred is batteries.
   The said cost saving made by said batteries which has total batteries' voltage is less than the LED or LEDs trigger voltage and use voltage raise-up electric components and related parts and accessories to make lower batteries' voltage raise-up to over the LED or LEDs trigger voltage to make the said LED or LEDs to turn on and turn off under predetermined function, effects, On/Off on certain % duration, cycles, color, brightness.

The details drawing attached below.

### DRAWINGS

FIG. 1 to FIG. 4: Disclosure the 1^{st} preferred embodiment of current invention has sealed-unit with self own laboratories test certifications incorporate with add-on different shades which made by bags which can fill up by air, liquid, miniatures items, laser film, hologram film or other material piece(S).

FIGS. 5-1 to 5-5: Disclosure the preferred construction for the sealed unit with different functions and features and interchangeable power source.

FIGS. 5 and 5-6 and 5-7: Disclosure the details construction of the preferred embodiment for how to assembly the add-on shade to the sealed-unit.

FIG. 6 and FIG. 7: Disclosure the 2^{nd} and embodiment has sealed unit with grilled or light block-out shade to make the LED or LEDs light beams to spread out to surrounding areas like electric wallpaper light effects.

FIG. 8, FIG. 9, FIG. 10, FIG. 11: Disclosure the preferred embodiment has rotating means and spin means and its preferred geometric shape substrate to inatall the said LED, LEDs, LED array on the said substrate to make the message, light pattern, color changing, time display to be seen by viewer.

FIG. 12 and FIG. 13: Disclosure the one of the splendid light images effects which created by the current invention to apply the faster changing LED, LEDs, LED arrays than the slow human eye reaction time. The illusion is based on inertia of a human eye.

### DETAIL DESCRIPTION

The current invention apply the Persistence of vision theory to the LED, LEDs, LED array to make light patterns, color changing, time display to viewers. The illusion is based on inertia of a human eye which has aournd 1/24 to 1/16 second time to response by human brain and eye. Hence, the LED or LEDs or LEDs array light be controlled faster than the 1/24 to 1/16 second for LED image will present the image on the people eyes and make all the LED images become continuously pictures to be seen.

Basing on this persistence of vision of human eye response time within 1/24 (41.67 msec) to 1/16 (0.0625 sec) second so while the object move faster than the human eye response time can make the last image stay in human eye and brain for a period of time of the last image. This theory can further use for LED or LEDs because LED or LEDs response time is very short which around 10 msec or less. Hence, If object show in front of human eye more than 16-24 pictures, than people will think all pictures are continuously. Hence, current invention further to use related circuit, control means, IC, micro controller to make the said LED or LEDs light device with blinking of said LED or LEDs with much faster than the 16-24 times(cycles) per second and make each cycle with 10% for turn-on and 90% for turn-off of the said LED or LEDs, then, can save up to 90% of the power consumption or we can say the battery life can increase 9 times than full steady-ON condition. This is really a power saving for all battery power source application. It is appreciated that the new LED technical may coming soon to make the LED with more quickly response time less than 10 msec, it maybe 5 msec time or 2 msec response time so can let more power saving. To adjust the Duration time of each cycles for turn-on and turn-off duration time will make more power saving device to meet green world concept. This is the other very important concept of current invention.

Further for Cost saving of battery powered unit to use less battery which lower than LED or LEDs trigger voltage battery number on device and use circuit with proper electric components and parts & accessories to make the battery's lower voltage to raise-up to higher voltage to trigger the said LED or LEDs can use less battery number for device. This can reduce people to use many many quantity of battery and save the cost to make battery operated LED light unit is other important concept for current invention.

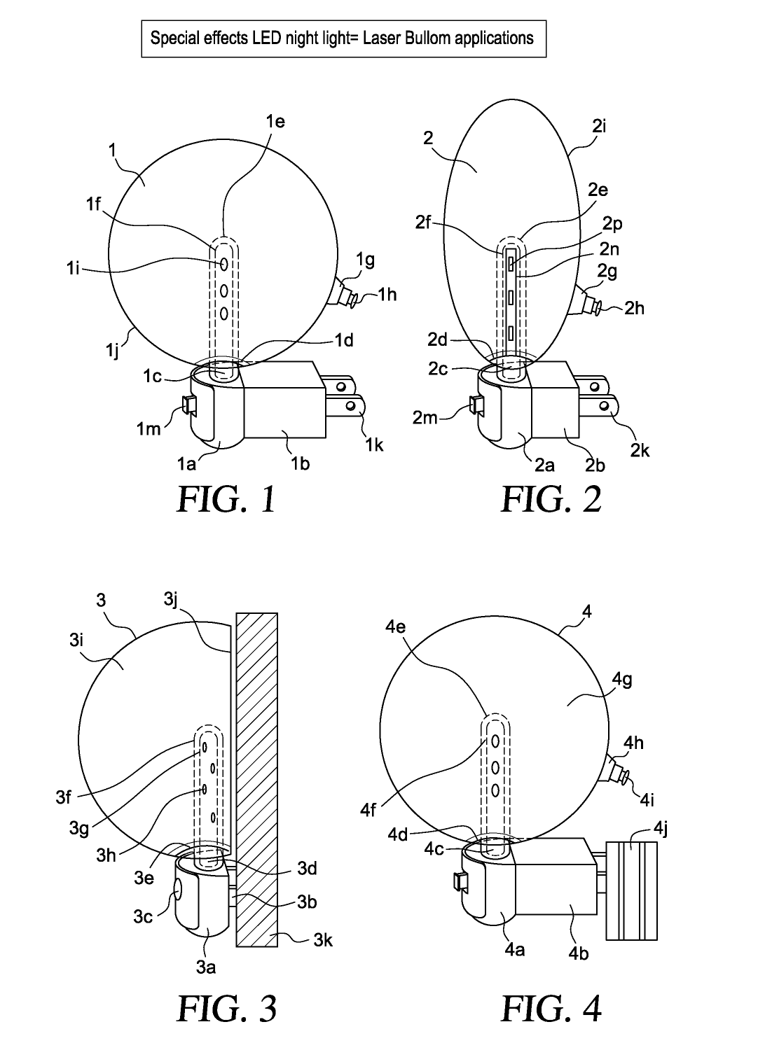

The current invention can has 14 features as above listed background discussion. Hereof, we do not repeat all details here. Hereof, the details discussion from FIG. 1 to FIG. 13 as below:

FIG. 1 to FIG. 4: Disclosure the 1^{st} preferred embodiment of current invention has sealed-unit with self own laboratories test certifications incorporate with add-on different shades which made by bags which can fill up by air, liquid, miniatures items, laser film, hologram film or other material piece(S). From FIG. 1 to FIG. 4 teach the sealed unit (1a)(2a)(3a)(4a) has the different rear parts (1b)(2b)(3b)(4b) which has different length from the wall to the sealed-unit to meet the top bloom shades (1) (2) (3)(4). Each bloom shade has the center channel (1e)(2e)(3f)(4e) which is easily to insert the tube parts (1f)(2f) (3g)(4f) of the sealed unit into the channel while Bloom did not fill up air, liquid, miniature stuffs. After the air, liquid, miniature stuffs filled into, the channels will become narrow and tightly hold the tube parts very and difficult to move away. The LED or LEDs inside the tube parts have variety of arrangement as the co-pending parents filing case as above listed continuity data list. The tube can be filled up reflective material, air bubbles, LEDs, glitters, air to make the desire light arrangement to make the whole shades with expected light performance.

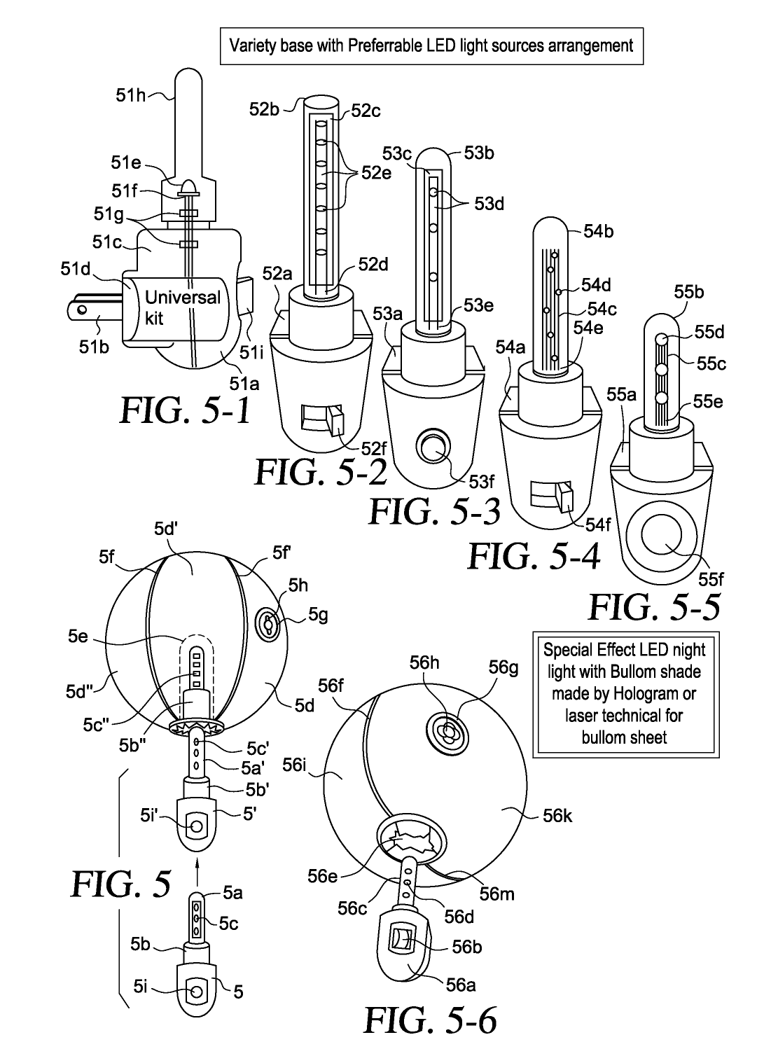

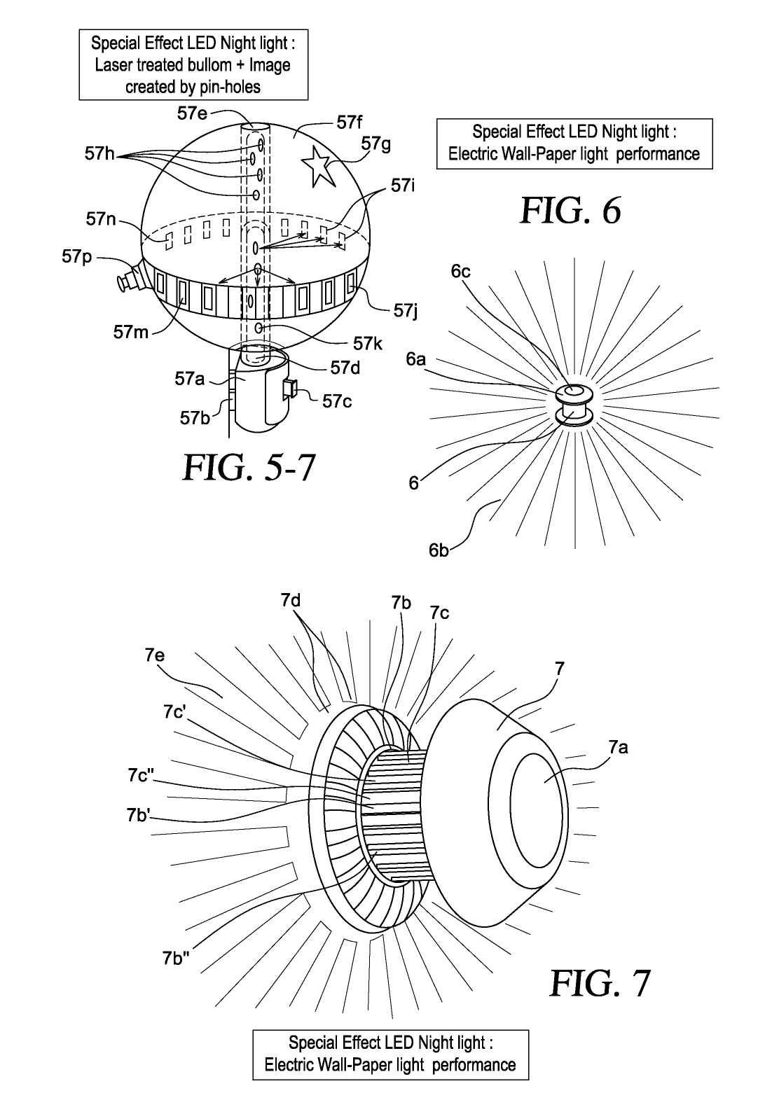

From FIG. 5-1 to FIG. 5-5 show the variety different function of the sealed unit. FIG. 5-1 has interchangeable power source (51d) has one LED (51e) on base of tube part (51h) and manual switch (51i). FIG. 5-2 has tube part (52b) and manual switch (520 and LEDs (52e) are installed on the elongate printed circuit board (52c). The FIG. 5-3 has tube part (53b) and auto sensor switch (530 and LEDs (53d) are installed on the PCB (53c). The FIG. 5-4 has manual switch (540 has tube part (54b) has plurality of LEDs on different direction are connected to the conductive wires to get multiple direction with LED illumination. The FIG. 5-5 has motion sensor switch (55f) has tube part(55B) has plurality of LED install on the flexible electric wires cable.

The co-inventor's More than 1 optics means 11-806,284 which teach the outer optic means to make the LEDs inside the 1^{st} tube parts optics means as parent application of the current invention. The FIG. 5 and FIGS. 5-6 and FIGS. 5-7 teach to use the laser or hologram film or pieces to form a bloom or assembly piece to add on the said tube parts to make special effects LED light device as the FIG. 5 and FIGS. 5-6 and FIGS. 5-7.

The FIG. 6 and FIG. 7 is similar with the co-pending filing of Ser. No. 12-622,000 Field on Nov. 24, 2009 file for the “Interchangeable Universal Kits for all LED light” and details are not discuss here.

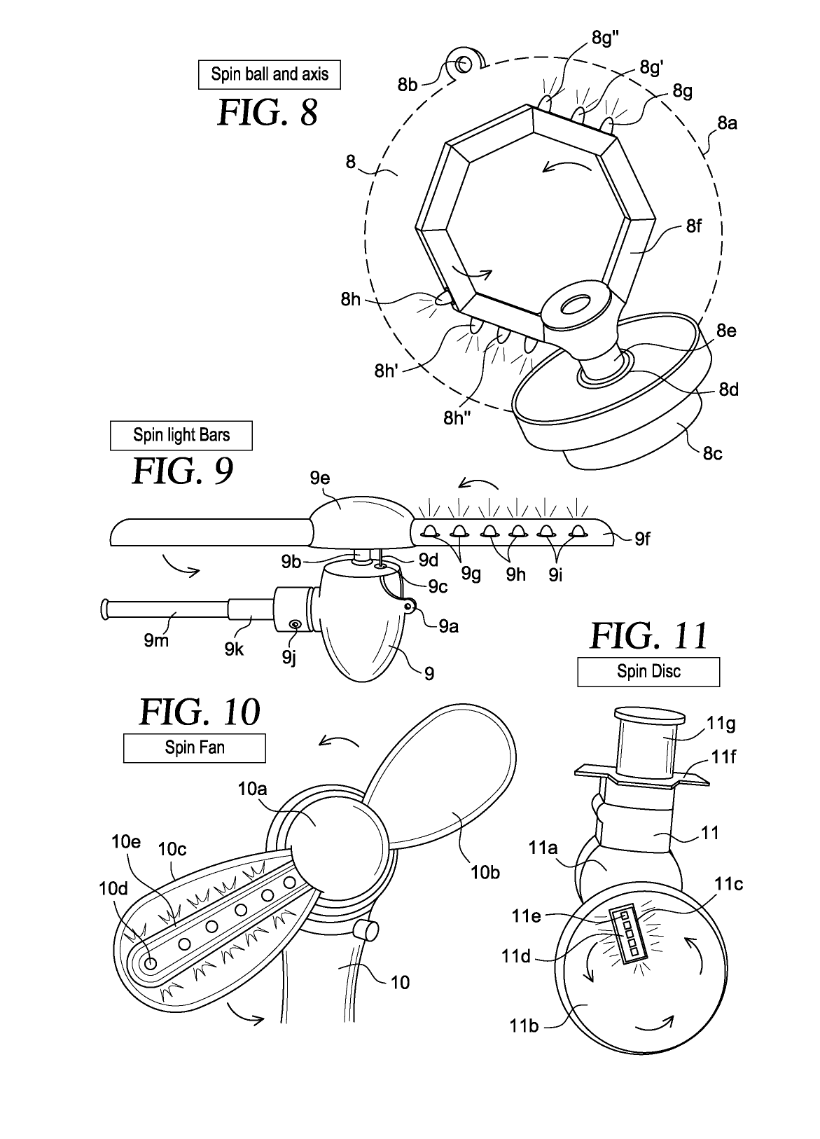

The FIG. 8 show the LED (8g) (8g′) (8g″), LEDs (8h) (8h′) (8h″) are install on substrate (80 which are assemble with spin means (not shown) which are inside the base housing (8c). The substrate are sealed within a transparent ball shape housing (8a) to allow people to see the said LED or LEDs light performance for desk top or outlet plug-in application which has vibration absorb means on the base (not shown) to prevent from any vibration while people put on desktop or plug-into outlet.

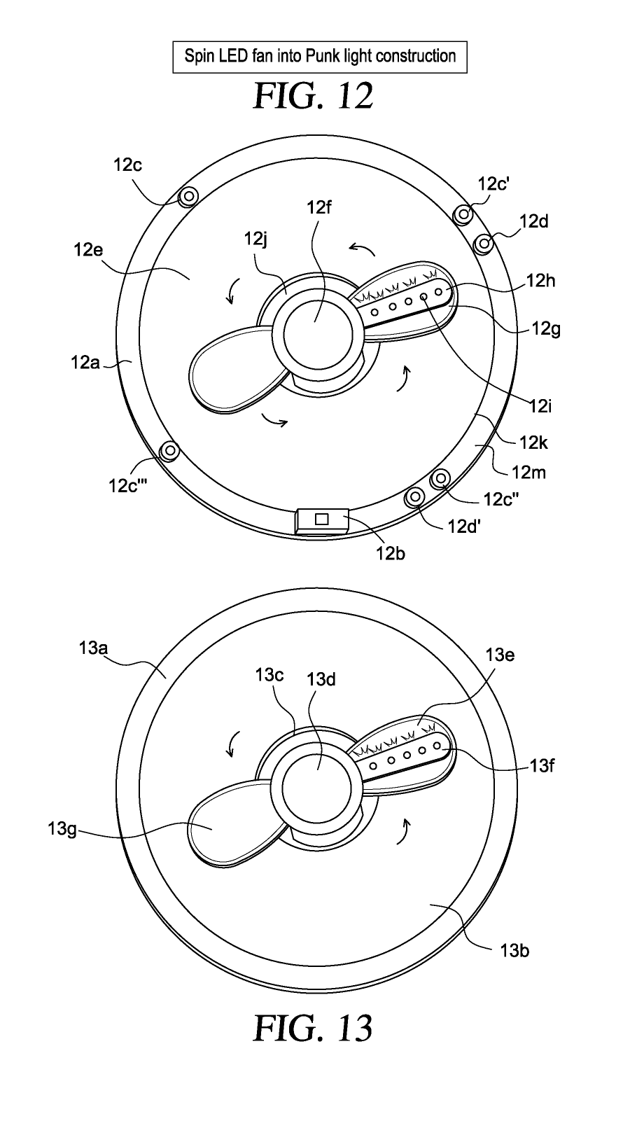

The FIG. 9 teach a soft material of substrate (90 in a bar shape design with a dome center area to make electric delivered by conductive means (9d) and spin means' conductive axis (9b). The dome center area also make assembly the said bars with the spin mean axis to make the two bars to be rotating while the switch (9j) or sensor or control means be activated by people. The Plurality of LEDs (9g) (9h) (9i) can be any number to make the desire message display including color, brightness, time, message, words presentation to viewer. The all LED or LEDs connect with circuit board or micro controller for time display (such as PIC 16F84) with accurate controller and Integrated circuit (hereafter as IC) can make the time, message, words display as wished as conventional market available skill. The spin means (not shown) can be a motor and sealed within the motor housing (9) with fasten means to make assembly with all related parts and accessories to make the said LED light device for desktop or plug-in application with a proper housing as FIG. 12 or FIG. 13 to make the final LED device.

The FIG. 10 and FIG. 11 same as the FIG. 9 and it has same LED or LEDs (10d) (11e) on the fan-blade (10c) round disc (11c) to make the fan-blades or round disc to be rotating aslong the axis of the spin means to make desired light performance. Also, It can has preferred housing to become a final LED light device as FIG. 12 and FIG. 13 drawing.

The FIG. 12 and FIG. 13 teach how to arrange the preferred embodiment of FIG. 7, FIG. 8, FIG. 9, FIG. 10 into the housing to become a final LED device with special effects. The device has its switch, sensor, timer, control means, circuit, micro controller, IC, conductive means, motor means and power source to make it have special LED light performance.

From above disclosure some preferred image would be created while the system are activated by switch, sensor, control means and power source, circuit means. It can be any kind of design, shape, display. Geometric shape of substrate and spin means while incorporated the said LED, LEDs, or LED array of current invention concept for special light effects to display time, message, words, color, patterns as wish.

From above discussion has limited preferred embodiments for current invention. It is appreciated all the alternative, equivalent, same function, replaceable skill, theory, arrangement, construction still fall within the current scope of invention and co-pending filing of light device with the project function.

1. LED light device has special effects consist of;
At least one of LED array are arranged on the substrate.
At least one of spin means to offer the certain rotating times per minute (hereafter as RPM) to make the substrate rotate under predetermined RPM along the axis extended from the spin means.
The said LED or LEDs will turn on and turn off under predetermined pattern, time, color, function, effects and connect with related circuit, switch, sensor, timer, auto turn on and turn off, power source (DC or AC or Interchangeable Power source), gear sets, motor, Integrated circuit (hereafter as IC), conductive means to make desired desire light effects, performance including the light patterns, message display, time display, color changing, words display, logo display, advertisement display.
The improvement of the said LED or LEDs light performance meet requirement of persistence of vision theory to create the illusion based on inertia of a human eye which has 1/16 to 1/24 second to response the image and the said LED or LEDs light performance is quickly than the 1/16 to 1/24 second to make the desire image to be seen by viewer.
The said LED light device has persistence of vision properties has housing to arrange the said substrate means, spin means, LED or LED or LED arrays, motor means, switch, sensor, circuit, IC, power source means within the said housing for desk top or outlet plug-in application.
The said LED light device further incorporate the vibration absorb means to absorb all motor or spin means vibration while people put the said device on desk top or plug-in outlet.

2. The LED light device has special effects consist of;
At least one LED or LEDs fit into the sealed unit which has its own safety certification issued by laboratories to meet the relative safety standard and has the receiving means to allow different shades to add on the said sealed unit to become a final LED light device.
The said add on shades which is made by plastic, paper, wood, laser piece, hologram piece, air-bag, bloom, assembly pieces, light block out means, grilled piece to make the said final LED light device has special light effects and eye-catching appearance.
The said final LED light device no need to pass any other laboratories further testament because the sealed unit already got its own safety testament certification so the said shade can use any kind of material to made of
The said Final LED light device incorporate with power source which may selected from battery, outlet, or interchangeable power source between Direct current and Alternative power source for desk top or plug-in application.

3. The LED light device has special effects as claim 1, the said the illusion is based on inertia of a human eye which is within the 1/16 to 1/24 second range to response the image to been seen by people's eye and LED or LEDs light changing have to be faster than the 1/16 to 1/24 second to let the people eye to remember the last image of LED or LEDs to become a Continuously picture to viewer.

4. The LED light device has special effects as claim 1, the said Housing can be a market available tap light which touch the top cover can activate the said device.

5. The LED light device has special effects as claim 1, the said housing can be a ball shape and has rotating means inside the ball means to show the special effects and spin means under the ball means to has better appearance.

6. The LED light device has special effects as claim 1, the said spin means is a motor with fan blades substrate to install the LED or LEDs or LED array within the said fan blade.

7. The LED light device has special effects as claim 1, the said spin means is a motor with bars substrate to install the LED or LEDs or LED array within the said bar.

8. The LED light device has special effects as claim 1, the said spin means is a motor with frame substrate to install the LED or LEDs or LED array within the said frame.

9. The LED light device has special effects as claim 1, the said spin means is a motor with round disc substrate to install the LED or LEDs or LED array within the said disc.

10. The LED light device has special effects as claim 1, the said spin means is a moto with geometric shape substrate to install the LED or LEDs or LED array with the said geometric shape substrate.

11. The LED light device has special effects as claim 1, the said switch, sensor, timer means to control the circuit to make its function as predetermined design.

12. The LED light device has special effects as claim 1, the said power source and be in DC power source, AC power source, or interchangeable power source which may come form battery, USB, Generator, chemical power source, green power source, wind power source, outlet, extension cord, power strips or other forms from the power generator device(s).

13. The LED light device has power saving features consist of;
At least one of LED or LEDs for light source.
At least one housing has space to install related preferred means which in desire combination select from circuit means, conductive means, electric components parts and accessories, switch means, sensor means, integrated circuit (IC), micro controller to connect with conventional market available power source to make the said LED or LEDs turn on and turn off under predetermined function, effects, On/Off on certain % duration, cycles, color, brightness.
The said power saving features made by control means to make the LED or LEDs turn-on and turn-off duration time on certain percentage of the each cycle. The said cycle means each second has certain times for turn-on and turn-off. The cycles number meet the persistence of vision of human eye which more quickly than the human eyes response time within 1/24 to 1/16 second so can make people see the blinking LED or LEDs look as continuously on status.

14. The LED light device has cost saving features consist of;
At least one of LED or LEDs for light source.
At least one housing has space to install related preferred means which in desire combination select from circuit means, conductive means, electric components parts and accessories, switch means, sensor means, integrated circuit (IC), micro controller to connect with conventional market available power source to make the said LED or LEDs turn on and turn off under predetermined function, effects, On/Off on certain % duration, cycles, color, brightness.
The said Power source preferred is batteries.
The said cost saving made by said batteries which has total batteries' voltage is less than the LED or LEDs trigger voltage and use voltage raise-up electric components and related parts and accessories to make lower batteries' voltage raise-up to over the LED or LEDs trigger voltage to make the said LED or LEDs to turn on and turn off under predetermined function, effects, On/Off on certain % duration, cycles, color, brightness.
